(19) United States
(12) Patent Application Publication
(10) Pub. No.: US 2016/0277547 A1
(43) Pub. Date: Sep. 22, 2016

(54) PACKET MONITORING DEVICE AND PACKET MONITORING METHOD FOR COMMUNICATION PACKET

(71) Applicant: ELECTRONICS AND TELECOMMUNICATIONS RESEARCH INSTITUTE, Daejeon (KR)

(72) Inventors: Byoung-Koo KIM, Daejeon (KR); Dong Ho KANG, Daejeon (KR); Jung-Chan NA, Daejeon (KR); Seon-Gyoung SOHN, Daejeon (KR); Youngjun HEO, Daejeon (KR)

(21) Appl. No.: 15/069,831

(22) Filed: Mar. 14, 2016

(30) Foreign Application Priority Data
Mar. 20, 2015 (KR) 10-2015-0039004

(51) Int. Cl. H04L 29/06

(52) U.S. Cl. CPC H04L 69/22; H04L 69/16

(57) ABSTRACT

Provided is a packet monitoring method for a communication packet transmitted and received between a server and a control device including receiving the communication packet transmitted and received between the server and the control device; determining whether the received communication packet is abnormal, based on a history table including control information on communication packets received before the received communication packet and control information on the received communication packet; and performing a security operation according to results of the determination.

### CROSS-REFERENCE TO RELATED APPLICATIONS

This U.S. non-provisional patent application claims priority under 35 U.S.C. §119 of Korean Patent Application No. 10-2015-0039004, filed on Mar. 20, 2015, the entire contents of which are hereby incorporated by reference.

### BACKGROUND

The present disclosure herein relates to a control system, and more particularly, to a packet monitoring device and a packet monitoring method for a communication packet.

A control system is a system for efficiently monitoring and managing a remote system and used for operating country's main infrastructures, such as power, gas, water and sewage, traffic, etc. The control system is changing from a closed communication network or dedicated OS to an open communication network and general OS in usage environment. Such a change has an ambivalent characteristic that increases the convenience of the control system but exposes security holes. In particular, as a closed control system protocol standard is gradually published as an international standard, the possibility and risk of cyber infringement of the control system is increasing.

The Distributed Network Protocol (DNP) 3.0 protocol among the above-described control system protocols is being broadly used in the control system, and is a protocol that takes a place as an industrial standard used in the fields of electricity, oil, gas, etc. However, the DNP3 protocol that has not considered a security aspect has various attack risks, such as spoofing, modification, etc. of a general network. That is, the DNP 3.0 protocol is taking a place as a general protocol standard of the control system but there is a limitation in that it is possible to easily attack by using weakness in security aspect. That is, since it is possible to attack the DNP 3.0 protocol with simple packet manipulation only, there is a possibility that a new type of attack may occur.

The Digital Bond corporation has disclosed sixteen weak points that have applied weak points of such a general network to the DNP 3.0 protocol, and the disclosed invasion detection rule is the invasion detection rule of Snort, is being provided to eleven main security companies, such as Cisco, 3com/Tipping Point, Symantec, etc., and is being used by them. However, since there are many unknown techniques for an attack pattern on a power network, there is a need to improve a traffic monitoring system depending on a typical signature to build a monitoring system through behavior based or abnormal behavior learning. In conclusion, in order to protect a stable service provision between control systems from an activity that obstructs the safe system operation of a main infrastructure due to an intended or unintended behavior, there is a need for a security technique suitable for a control system protocol.

### SUMMARY

The present disclosure provides a packet monitoring device that abnormally senses an abnormal communication packet on a distributed network protocol, and a packet monitoring method for a communication packet.

Embodiments of the inventive concept provide packet monitoring methods for a communication packet transmitted and received between a server and a control device including receiving the communication packet transmitted and received between the server and the control device; determining whether the received communication packet is abnormal, based on a history table including control information on communication packets received before the received communication packet and control information on the received communication packet; and performing a security operation according to results of the determination, wherein the control information includes a function code filed of application protocol control information on the communication packet, a sequence bit of the application protocol control information, a source field of a link header, a destination filed of the link header, a start bit of a transport header, and a finish bit of the transport header.

In an embodiment, the server and the control device may transmit and receive the communication packet based on distributed network protocol (DNP) 3.0.

In an embodiment, the determining of whether the received communication packet is abnormal may include classifying the received communication packet as any one of first to fifth types of abnormal communication packets.

In an embodiment, the first type of abnormal communication packet may indicate an abnormal communication packet that is not present between the server and the control device, the second type of abnormal communication packet may indicate an abnormal communication packet that is against normal communication between the server and the control device, the third type of abnormal communication packet may indicate an abnormal communication packet that is retransmitted with respect to a communication packet that transmission and reception are completed between the server and the control device, the fourth type of abnormal communication packet may indicate an abnormal communication packet that is against a normal sequence bit between the server and the control device, and the fifth type of abnormal communication packet may indicate an abnormal communication packet that causes abnormal message insertion between the server and the control device.

In an embodiment, the classifying of the received communication packet as any one of the first to fifth types of abnormal communication packets may include classifying the received communication packet as the first type of abnormal communication packet based on the source field of the link header of the received communication packet and the function code field of the application protocol control information.

In an embodiment, the classifying of the received communication packet as the first type of abnormal communication packet may include classifying the received communication packet as the first type of abnormal communication packet when the source field of the link header of the received communication packet indicates the server, the function code field has a value corresponding to a response or an unsolicited response or the source field of the link header of the received communication packet indicates the control device and the function code field has a value corresponding to a request.

In an embodiment, the classifying of the received communication packet as any one of the first to fifth types of abnormal communication packets may include classifying the received communication packet as the second type of abnormal communication packet based on sequence bits and received times of the previously received communication packets in the history table.

In an embodiment, the classifying of the received communication packet as the second type of abnormal communication packet may include classifying the received communication packet as the second type of abnormal communication packet when a communication packet having a same sequence bit as the received communication packet among the previously received communication packets in the history table is received before a certain time.

In an embodiment, the classifying of the received communication packet as any one of the first to fifth types of abnormal communication packets may include classifying the received communication packet as the third type of abnormal communication packet according to whether transmission and reception of communication packets corresponding to the received communication packet among the previously received communication packets are completed.

In an embodiment, the classifying of the received communication packet as any one of the first to fifth types of abnormal communication packets may include classifying the received communication packet as the third type of abnormal communication packet when transmission and reception of a communication packet having a same sequence bit as the received communication packet among the previously received communication packets are completed based on the history table.

In an embodiment, the classifying of the received communication packet as any one of the first to fifth types of abnormal communication packets may include classifying the received communication packet as the fourth type of abnormal communication packet based on sequence bits of the previously received communication packets in the history table.

In an embodiment, the classifying of the received communication packet as the fourth type of abnormal communication packet may include classifying the received communication packet as the fourth type of abnormal communication packet when a sequence bit of the received communication packet is different from a sequence bit according to the DNP 3.0 based on sequence bits of the previously received communication packets in the history table.

In an embodiment, the classifying of the received communication packet as any one of the first to fifth types of abnormal communication packets may include classifying the received communication packet as the fifth type of abnormal communication packet based on start bits and finish bits of the link header of the previously received communication packets in the history table.

In an embodiment, the classifying of the received communication packet as the fifth type of abnormal communication packet may include classifying the received communication packet as the fifth type of abnormal communication packet when a communication packet having a start bit of ‘1’ is received before a communication packet transmitted from the control device to the server and having a finish bit of ‘1’ is received.

In embodiments of the inventive concept, packet monitoring devices include a DNP physical layer configured to receive a communication packet transmitted and received between a server and a control device, and release the received communication packet to generate control information and a message; a communication packet analysis module configured to manage the control information on the received communication packet; a history table configured to store the control information on the received communication packet and control information on a communication packet received before the received communication packet; an abnormal packet detection and classification module configured to determine whether the received communication packet is an abnormal communication packet, based on the control information on the previously received communication packet stored in the history table and the control information on the received communication packet; and a control module configured to perform a security operation according to results of the determination of the abnormal packet detection and classification module, wherein the control information includes a function code filed of application protocol control information on the communication packet, a sequence bit of the application protocol control information, a source field of a link header, a destination filed of the link header, a start bit of a transport header, and a finish bit of the transport header.

In an embodiment, the server and the control device may transmit and receive the communication packet based on DNP 3.0.

In an embodiment, the DNP physical layer may include a DNP 3.0 data link layer configured to extract the link header from the received communication packet; a DNP 3.0 transport layer configured to extract the transport header from the received communication packet; and a DNP 3.0 application layer configured to extract the application protocol control information from the received communication packet.

In an embodiment, the server and the control device may communicate with each other through a TCP/IP protocol based communication line, and the DNP physical layer may further include a communication protocol layer configured to extract an Ethernet header, an IP header, and a TCP header from the received communication packet.

In an embodiment, the abnormal packet detection and classification module may be configured to classify the received communication packet as any one of first to fifth types of abnormal communication packets based on control information on the previously received communication stored in the history table and control information on the received communication packet.

In an embodiment, the first type of abnormal communication packet may indicate an abnormal communication packet that is not present between the server and the control device, the second type of abnormal communication packet may indicate an abnormal communication packet that is against normal communication between the server and the control device, the third type of abnormal communication packet may indicate an abnormal communication packet for a communication packet that transmission and reception are completed between the server and the control device, the fourth type of abnormal communication packet may indicate an abnormal communication packet that is against a normal sequence bit between the server and the control device, and the fifth type of abnormal communication packet may indicate an abnormal communication packet that causes abnormal message insertion between the server and the control device.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram showing a control system according to an embodiment of the inventive concept;

FIG. 2 is a block diagram specifying a server, control device, and packet monitoring device of FIG. 1;

FIG. 3 is a block diagram specifying the physical layer of the DPN 3.0 protocol of FIG. 2;

FIG. 4 is a diagram for explaining a data structure on each layer of FIG. 3;

FIG. 5 is a diagram specifying a data fragment of FIG. 4;

FIG. 6 is a diagram specifying a data segment of FIG. 4;

FIG. 7 is a diagram specifying a data frame of FIG. 4;

FIGS. 8 and 9 are diagrams showing communication between the server and control device of FIG. 2;

FIG. 10 is a block diagram specifying a packet monitoring device of FIG. 2;

FIG. 11 is a flowchart of an operation of the packet monitoring device of FIG. 10;

FIG. 12 is a flowchart of another operation of the packet monitoring device of FIG. 10;

FIGS. 13 to 17 are diagrams for explaining first to fifth types of an abnormal packet, respectively; and

FIG. 18 is a diagram illustrating a computer system to an embodiment of the inventive concept.

### DETAILED DESCRIPTION

In the following, embodiments of the inventive concept are described with reference to the accompanying drawings in order to describe the inventive concept in detail so that a person skilled in the art to which the inventive concept pertains may easily practice the technical spirit of the inventive concept.

In this specification, components which are described with reference to terms “unit”, “module”, “layer”, and the like may be implemented with software, hardware, or a combination thereof. In exemplary embodiments, software may be firmware, embedded code, and application software. For example, hardware may include a circuit, a processor, a computer, an integrated circuit, integrated circuit cores, a pressure sensor, an inertial sensor, microelectromechanical system (MEMS), a passive element, or a combination thereof.

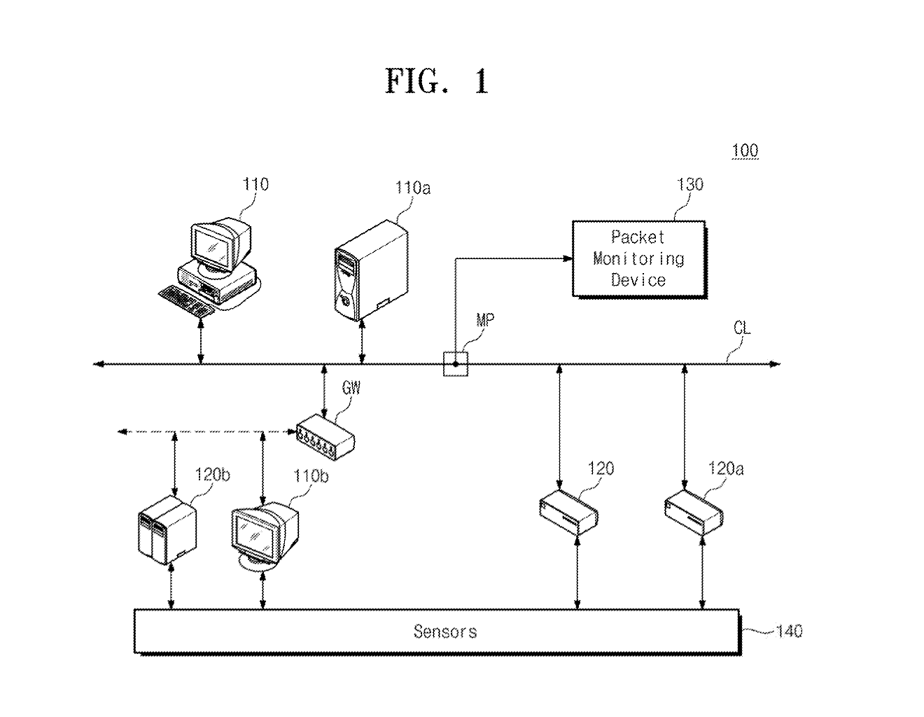

FIG. 1 is a block diagram showing a control system according to an embodiment of the inventive concept. Referring to FIG. 1, a control system 100 includes servers 110, 110a and 110b, control devices 120, 120a, and 120b, sensors, and a packet monitoring device 130. As an example, the control system 100 may be a closed control system that is used in a system requiring safety or security, such as power, gas, water and sewage, traffic, etc.

The servers 110, 110a, and 110b may function as the server of the control system 100. For example, the servers 110, 110a and 110b may control the control devices 120, 120a, and 120b. As an example, the servers 110, 110a, and 110b respectively may communicate with the control devices 120, 120a and 120b through a communication line CL or gateway GW. For example, the server 110 and the control device 120 may communicate through the communication line CL. The server 110a and the control device 120b may communicate through the communication line CL and the gateway GW. As an example, the servers 110, 110a, and 110b may include a control server device, such as a human machine interface (HMI), SCADA server, etc.

The control devices 120, 120a and 120b may communicate with the server devices 110, 110a, and 110b through the communication line CL or gateway GW. The control devices 120, 120a, and 120b may control a plurality of sensors according to the control of the servers 110, 110a, and 110b or provide information sensed from the plurality of sensors to the servers 110, 110a, and 110b. As an example, the control devices 120, 120a, and 120b may include outstation devices or field control devices, such as PLC, IED, RTU, etc. As an example, the communication line CL may be a communication line according to a predetermined communication protocol. That is, when the server and the control device communicate through the communication line CL, each of the server and the control device may transmit and receives a communication packet defined according to the predetermined communication protocol. As an example, the communication line CL may be a communication line on the TCP/IP protocol. In this case, the server 110 and the control device 120 may transmit and receive a communication packet defined by the TCP/IP protocol.

The packet monitoring device 130 may monitor a communication packet transmitted and received through the communication line CL between the servers 110, 110a, and 110b and the control devices 120, 120a, and 120b. For example, the packet monitoring device 130 may receive a communication packet provided through a mirroring port MP on the communication line CL and manage code information on the received communication packet. The packet monitoring device 130 may determine based on the managed code information and the received communication packet whether the received communication packet is an abnormal communication packet (or abnormal traffic), and classify the type of the received communication packet when the received communication packet is the abnormal communication packet.

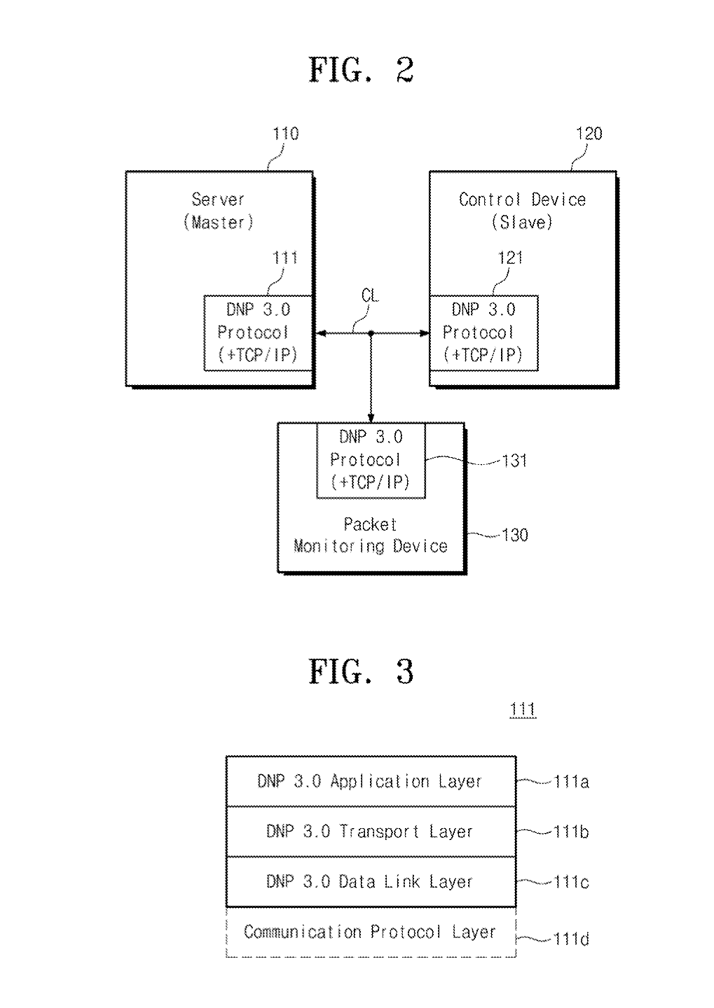

FIG. 2 is a block diagram specifying the server, control device, and packet monitoring device of FIG. 1. In the following, for the simplicity of description, embodiments of the inventive concept are described centered around the packet monitoring device 130 that monitors a communication packet is transmitted and received between the server 110 and the control device 120. In this case, it is assumed that the server 110 is a master device, and the control device 120 is a slave device. Also, it is assumed that the sever 110 and the control device 120 transmits and receives information according to the DNP 3.0 protocol and a communication packet is transmitted and received through the communication line CL according to the TCP/IP protocol. That is, the server 110 and the control device 120 transmit and receive a communication packet defined by the TCP/IP protocol and the communication packet includes data units defined by the DNP 3.0 protocol.

However, the technical spirit of the inventive concept is not limited to the above-described assumptions, and the servers 110, 110a, and 110b and the control devices 120, 120a, and 120b each may transmit and receive a communication packet, and the packet monitoring device 130 may monitor a communication packet that is transmitted and received between the servers 110, 110a, and 110b and the control devices 120, 120a, and 120b. Also, the servers 110, 110a, and 110b and the control devices 120, 120a, and 120b may perform serial communication through a serial communication line (a dotted line of FIG. 1) through the gateway GW. In this case, the servers 110, 110a, and 110b and the control devices 120, 120a, and 120b may transmit and receive a data unit defined by the DNP 3.0 protocol, through a serial communication line (a dotted line of FIG. 1).

Referring to FIGS. 1 and 2, the control system 100 includes the server 110, the control device 120, and the packet monitoring device 130.

Each of the server 110 and the control device 120 may transmit and receive a packet through the communication line CL. The server 110, the control device 120, and the packet monitoring device 130 respectively includes physical layers 111, 121, and 131 according to the DNP 3.0 protocol. The physical layers 111, 121, and 131 according to the DNP 3.0 protocol perform an operation of converting a message to be transmitted into a communication packet in a format defined by the DNP 3.0 protocol or inversely converting a received communication packet into a message.

As an example, when the communication line CL is a communication line according to the TCP/IP protocol, each of the physical layers 111, 121, and 131 may further include physical layers according to the TCP/IP protocol. That is, the physical layers 111, 121, and 131 may convert a message to be transmitted into a format defined by the DNP 3.0 protocol and convert the format obtained through conversion into a communication packet in a format defined by the TCP/IP protocol. As an example, when the communication line CL is a serial communication line, the physical layer according to the TCP/IP protocol may be omitted.

As an example, the server 110 may be a master device and the control device 120 may be a slave device. That is, the server 110 may transmit a request RQ to the control device 120, and the control device 120 may transmit a response RP to the server 110 in response to the request RQ from the server 110. Alternatively, the control device 120 may transmit unsolicited response URP to the server 110. The above-described request RQ, response RP, and unsolicited response URP may be provided in format defined by the DNP 3.0 protocol and included in a communication packet defined by the TCP/IP protocol.

FIG. 3 is a block diagram specifying the physical layer of the DPN 3.0 protocol of FIG. 2. As an example, although the physical layer 111 of the server 110 is described with reference to FIG. 3, the physical layers 121 and 131 of the control device 120 and the packet monitoring device 130 may have the same hierarchical structure as the physical layer shown in FIG. 3.

Referring to FIGS. 2 and 3, the physical layer 111 of the server 110 may include a DNP 3.0 application layer 111a, a DNP 3.0 transport layer 111b, a DNP 3.0 data link layer 111c, and a communication protocol layer 111d.

The DNP 3.0 application layer 111a may add control information to a message to be transmitted from the server 110 to standardize the message. As an example, the message standardized on the DNP 3.0 application layer 111a is referred to as an application protocol data unit (APDU) or DNP 3.0 fragment. In the following, the message standardized on the DNP 3.0 application layer 111a is referred to as a data fragment (DNP 3.0 fragment).

The DNP 3.0 transport layer 111b divides the data fragment into certain units and adds a transport header to each of the units obtained through division. Units processed at the DNP 3.0 transport layer 111b are referred to as a Transport Protocol Data Unit (TPDU) or DNP 3.0 segment. In the following, the data processed at the DNP 3.0 transport layer 111b is referred to as a data segment (DNP 3.0 segment).

The DNP 3.0 data link layer 111c adds a link header to each of the data segments. The data segments processed at the DNP 3.0 data link layer 111c are referred to as a Link Protocol Data Unit (LPDU) or DNP 3.0 frame. In the following, the data segments processed at the DNP 3.0 data link layer 113 are referred to as a data frame (DNP 3.0 frame).

The communication protocol layer 111d may process data frames according to the protocol of the communication line CL. As an example, in the case that the communication line CL is based on the TCP/IP protocol, the communication protocol 111d may include a transport layer, a network layer, and a link/physical layer and process data frames according to the TCP/IP protocol.

The processed data frames are transmitted as communication packets to the control device 120 and the packet monitoring device 130 through the communication line CL.

As an example, when the server 110 receives a communication packet (i.e., response RP or unsolicited response URP) from the control device 120, each layer of the server 110 may release the communication packet in the reverse order from the above-described order to extract a message.

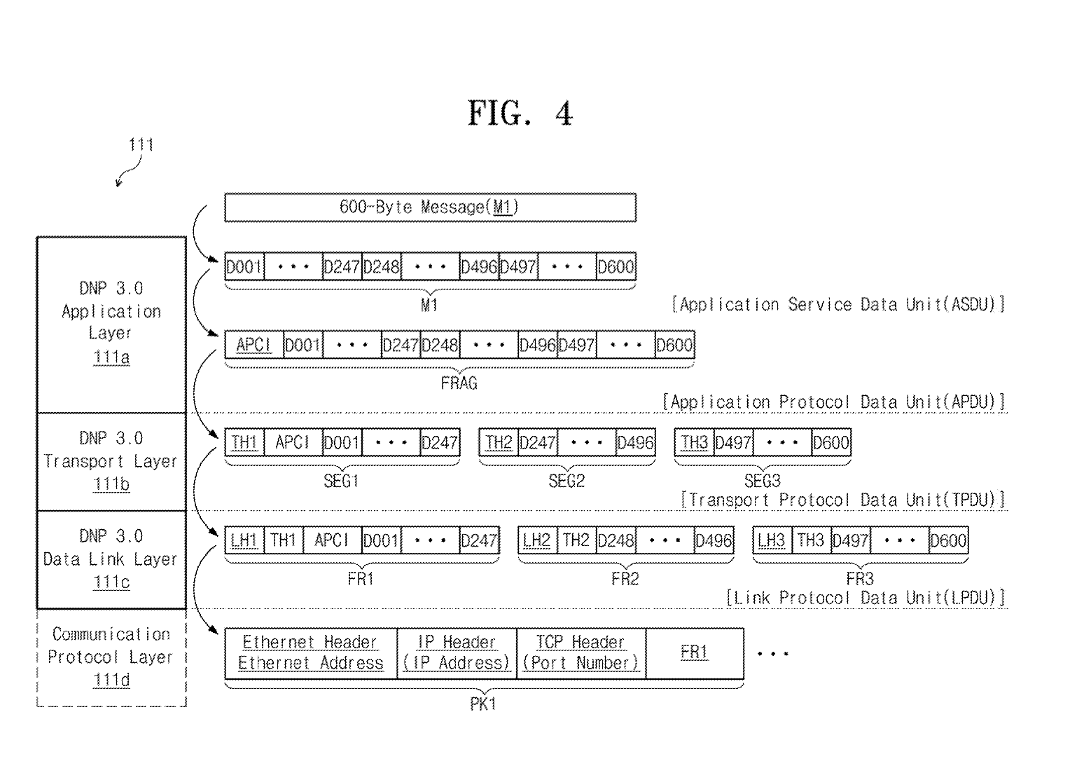

FIG. 4 is a diagram for explaining the data structure at each layer of FIG. 3. As an example, a data structure when a 600-byte message M1 is transmitted from the server 110 is shown in FIG. 4. However, the scope of the inventive concept is not limited thereto, the size of the message may vary, and according to the protocol at each layer, the message may be further divided or data units may be further generated.

Referring to FIGS. 3 and 4, the message M1 may include first to six hundredth data D001 to D600. The size of each of the first to six hundredth data D001 to D600 is 1-byte. The DNP 3.0 application layer 111a may convert the message into an Application Service Data Unit (ASDU). The DNP 3.0 application layer 111 may add Application Protocol Control Information APCI to the application service data unit to generate a data fragment FRAG. That is, the data fragment FRAG includes the application protocol control information APCI and the first to six hundredth data D001 to D600. As an example, the data fragment FRAG is an APDU. As an example, the application protocol control information APCI may include various pieces of information on the message.

As an example, the maximum size of the data fragment FRAG defined by the DNP 3.0 protocol may be limited to 2048 bytes. The size of the application protocol control information APCI may be 2 bytes. In this case, when the message exceeds 2046 bytes, the DNP 3.0 application layer 111a may divide the message in units of 2046 bytes and add the application protocol control information APCI to each of the divided messages to generate a plurality of data fragments. As an example, the size of the application protocol control information APCI may vary in size according to the type of the message.

The DNP 3.0 transport layer 111b may divide the data fragment FRAG in certain units and add first to third transport headers TH1 to Th3 to each of the divided data fragments to generate first to third data segments SEG1 to SEG3. For example, the maximum size of the data segment defined by the DNP 3.0 protocol may be limited to 250 bytes. The size of each of the first to third transport headers TH1 to TH3 may be four bytes. The DNP 3.0 transport layer 111b adds the first transport header TH1 to the application protocol control information APCI of the data fragment FRAG and the first to 247th data D001 to D247 to generate the first data segment SEG1. Likewise, the DNP 3.0 transport layer 111b may generate the second data segment SEG2 based on the 248th to 496th data D248 to D496 and the second transport header TH2, and generate the third segment SEG3 based on the 497th to 600th data D497 to D600 and the third transport header TH3. As an example, the first to third data segments SEG1 to SEG3 may be TPDUs.

Next, the DNP 3.0 data link layer 111c may add first to third link headers LH1 to LH3 to each of the first to third segments SEG1 to SEG3 to generate first to third data frames FR1 to FR3. As an example, each of the first to third data frames FR1 to FR3 may include a 10-byte link header, a 250-byte data segment, and a 32-byte cyclic redundancy check (CRC) code.

The communication protocol 111d adds communication protocol based information to the first to third data frames FR1 to FR3 to generate a communication packet. For example, in the case that the communication protocol of the communication line CL is TCP/IP, the communication line protocol layer 114 adds information, such as an Ethernet header, an IP header, and a TCP header to each of the first to third data frames FR1 to FR3 to generate a communication packet. The generated communication packet is transmitted to the control device 120 through the communication line CL.

As an example, the unit and packet structure of each layer shown in FIG. 4 and exemplary and the scope of the inventive concept is not limited thereto. The number of units at each layer may vary according to the type and size of a message and the maximum size of a unit at each layer.

Also, the control device 120 may perform communication based on the same layer structure as that shown in FIG. 4. Also, the packet monitoring device 130 may release a received communication packet based on the same layer structure as that shown in FIG. 4.

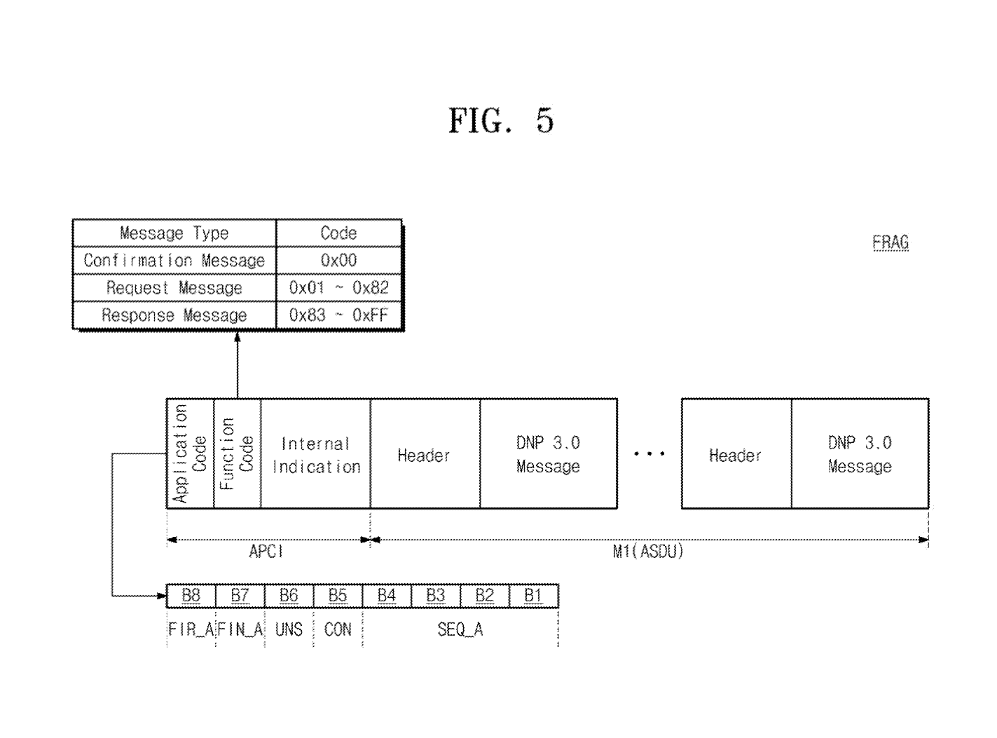

FIG. 5 is a diagram specifying the data fragment of FIG. 4. Referring to FIG. 5, the data fragment FRAG includes application protocol control information APCI and a message M1 (or ASDU). The application protocol control information APCI includes control information on the message M1. For example, the application protocol control information APCI includes an application control field, a function code field, and an internal indication field.

The application control field includes a start bit FIR_A, a finish bit FIN_B, a CON bit, unsolicited response bit UNS, and a sequence bit SEQ_A. The start bit FIR_A is the seventh bit B7 of the application control field and indicates whether the current data fragment is a first data fragment. For example, in the case that the start bit FIR_A is set to ‘1’, the current data fragment is a first data fragment.

The finish bit FIN_A is the sixth bit B6 of the application control field and indicates whether the current data fragment FRAG is the last data fragment. For example, in the case that the finish bit FIN_A is set to ‘1’, the data fragment is the last data fragment.

The CON bit is the fifth bit B5 of the application control field. When the CON bit is set to ‘1’, a device receiving a communication packet (i.e., a communication packet having a CON bit of ‘1’) should return an application layer acknowledgment message. As an example, in the case of a request message from the server 110 the CON bit is not set. As an example, in the case of an unsolicited response URP from the control device 120, the CON bit is set to ‘1’. As an example, in the case that the CON bit is set in a response RP of multiple fragments (i.e., in the case that the size of a message is larger than the maximum size of a data fragment), the CON bit of the last data fragment (i.e., the finish bit FIN_A is set to ‘1’) is optionally set. As an example, in the case of a response of the control device 120 that has no event on a request RQ from a server 110, the CON bit may not be set.

The unsolicited response bit UNS is the fourth bit B4 of the application control field and indicates whether the current data fragment FRAG is the unsolicited response URP. For example, in the case that the unsolicited response bit UNS is set to ‘1’, it is a unsolicited response when the data fragment FRAG is transmitted from the control device 120.

The sequence bit SEQ_A includes the first to fourth bits B1 to B4 of the application control filed and indicates an identification number for identifying a transmitted and received message. As an example, a response RP of the control device 120 to the request RQ from the server 110 has the same sequence bit SEQ_A as the request RQ. As an example, the sequence bit SEQ_A of the request RQ from the server 110 increases by ‘1’ except for retry. As an example, the sequence bit SEQ_A of the request RQ from the server 110 and the sequence bit SEQ_A of the response RP from the control device 120 are managed independently from each other. As an example, a sequence bit managed in communication between the server 110 and the control device 120 and a sequence bit managed in communication between the server 110 and other control devices 120 are managed independently from each other.

The function code field indicates the type of a data fragment FRAG. That is, the function code field includes information on whether the data fragment FRAG is the request RQ, response RP or confirmation CF. As an example, the function code field includes 1-byte information. In the case that the data fragment FRAG is the confirmation CF, the confirmation function code has a value of 0x00. In the case that the data fragment FRAG is the request RQ, the confirmation function code has a value between 0x01 and 0x82. In the case that the data fragment FRAG is the response RP, the confirmation function code has a value between 0x83 and 0xFF.

The internal indication field may be omitted according to the type of the data fragment FRAG. For example, in the case that the data fragment FRAG is the request RQ, the internal indication field is omitted.

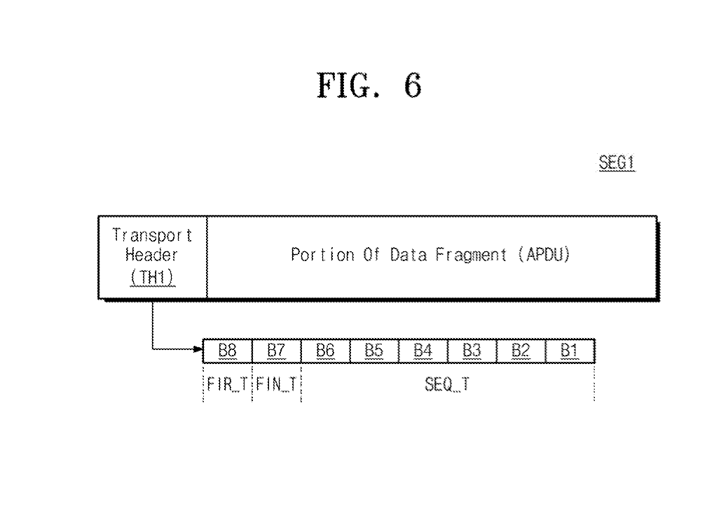

FIG. 6 is a diagram specifying the data segment of FIG. 4. As an example, the first data segment SEG1 is described with reference to FIG. 6 but the scope of the inventive concept is not limited thereto, and the second and third segments SEG2 and SEG3 or other data segments may also have a similar data structure to the first data segment SEG1 of FIG. 6.

Referring to FIG. 6, the first data segment SEG1 may include a first transport header TH1 and a portion of the data fragment FRAG. As an example, the portion of the data fragment FRAG may have a size of 249 bytes and include application protocol control information ACPI and first to 247th data D001 to D247.

The first transport header Th1 has a size of 1 byte and includes a start bit FIR_T, a finish bit FIN_T, and a sequence bit SEQ_T. The start bit FIR_T is the seventh bit B7 of the first transport header TH1 and indicates that the current data segment is a first data segment. For example, in the case that the start bit FIR_T is set to ‘1’, the first data segment SEG1 is a first data segment.

The finish bit FIN_T is the eighth bit B8 of the first transport header TH1 and indicates that the current data segment is the last data segment. For example, in the case that the finish bit FIN_T is set to ‘1’, the first data segment SEG1 is the last data segment.

The sequence bit SEQ_T includes the first to sixth bits B1 to B6 of the first transport header TH1 and indicates the identification number of the current data segment. As an example, the sequence bit SEQ_T of the data segment in which the start bit FIR_T is set to ‘1’ has a value between zero and 63 irrespective of the previous data segment.

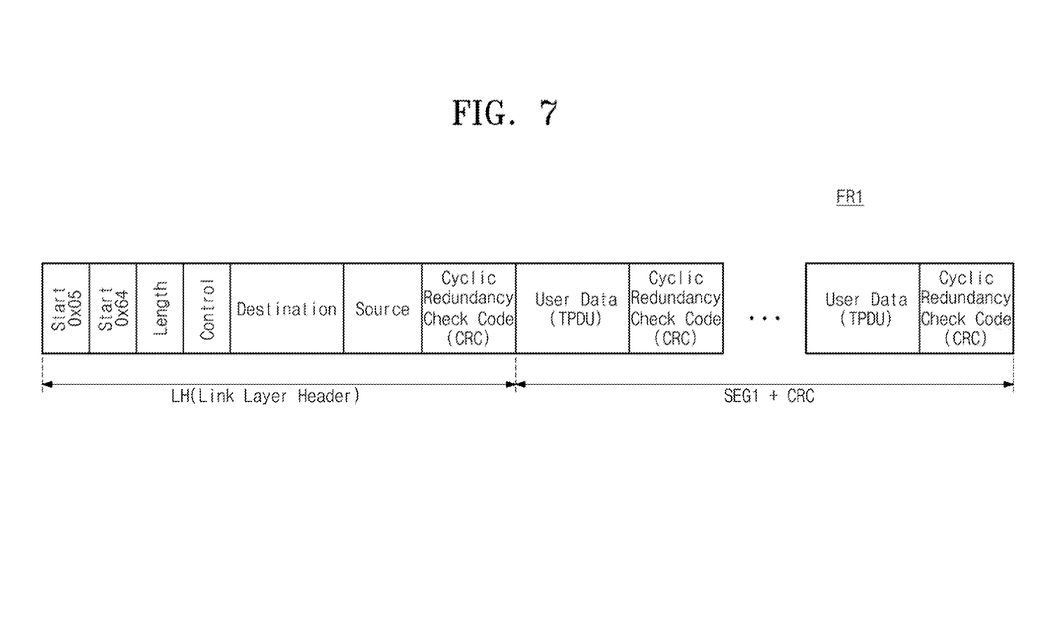

FIG. 7 is a diagram specifying a data frame of FIG. 4. As an example, a first data frame FR1 is described with reference to FIG. 7 but the scope of the inventive concept is not limited thereto. Second and third data frames FR2 and FR3 and other data frames may also have a similar data structure to the first data frame FR1 of FIG. 7.

Referring to FIG. 7, the first data frame FR1 includes a first link header LH1, a first data segment SEG1, and a CRC code. The first link header LH1 includes start fields, a length field, a control field, a destination field, a source field, and a CRC code field.

Each of the start fields has a size of 1 byte and they have values of 0x05 and 0x64, respectively. The length filed includes information on the length of the entire data frame and has a size of 1 byte. The control field has a size of 1 byte and includes information for control at the DNP 3.0 data link layer 111c.

The destination field has a size of 2 bytes and includes information on a destination device to which the first data frame FR1 is transmitted. The source field has a size of 2 bytes and includes information on a device to which the first data frame FR1 is transmitted.

As an example, it is possible to identify the destination device and the source device through the destination field and the source field. As an example, it is possible to identify the destination device and the source device through the IP address of the TCP/IP protocol, but in the case that a plurality of logical devices are connected to one IP or serial communication is performed, it is possible to identify the destination device and the source device based on the above-described destination field and source field.

As an example, the data format of the server 110 communicating based on the DNP 3.0 protocol has been described with reference to FIGS. 4 to 7. However, the scope of the inventive concept is not limited thereto, the control device 120 may also communicate based on the above-described data format and the packet monitoring device 130 may also monitor a received communication packet based on the above-described data format.

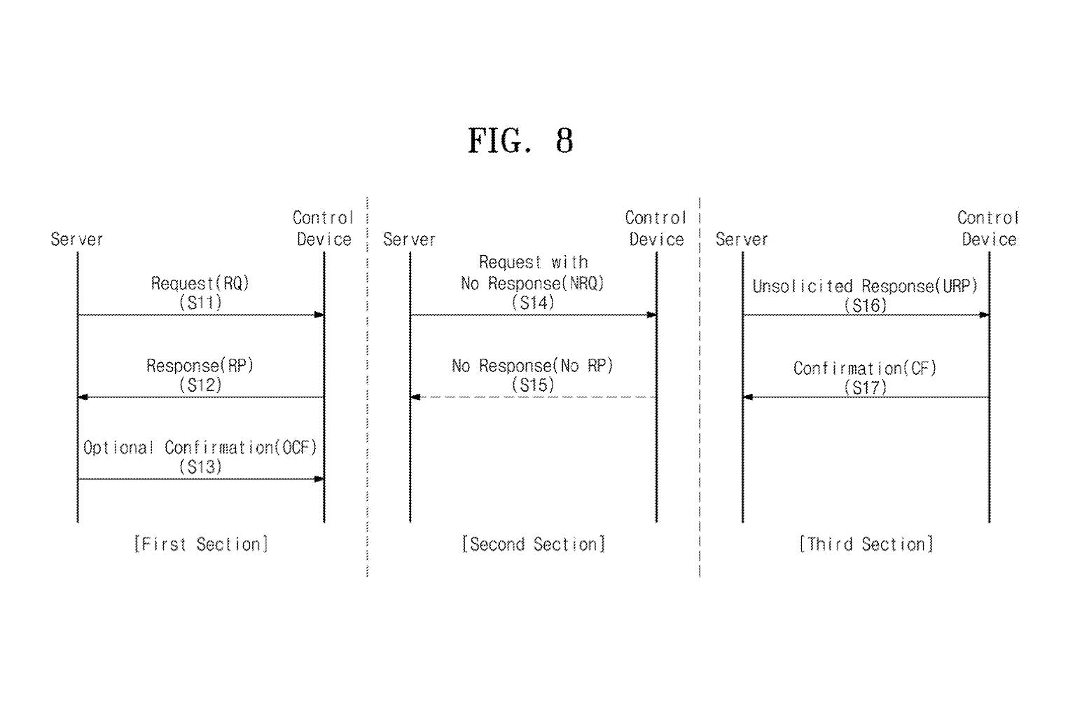

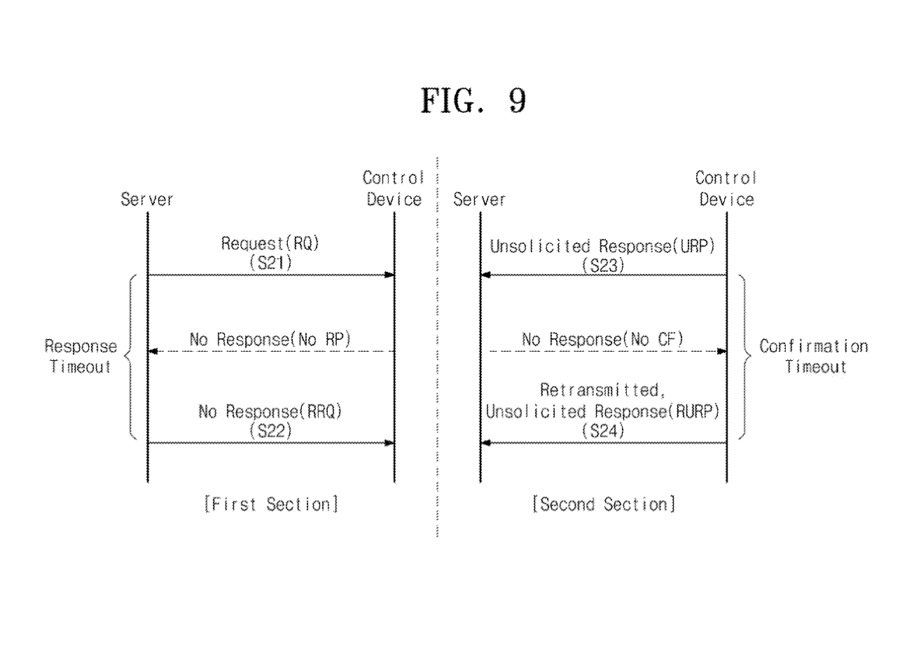

FIGS. 8 and 9 are diagrams showing communication between the server and control device of FIG. 2. As an example, communication packets (e.g., request RQ, response RP, unsolicited response URP, etc.) described with reference to FIGS. 8 and 9 may include a communication packet defined by the DNP 3.0 protocol. That is, the communication packets described with reference to FIGS. 8 and 9 may include data frames RF that have been described with reference to FIGS. 4 to 7.

Firstly, referring to FIGS. 2 and 8, the server 110 transmits the request RQ to the control device 120 in step S11, as shown in a first section of FIG. 8. In step S12, the control device 120 transmits the response RP to the server 110 in response to the request RQ. In step S13, the server 110 may transmit optional confirmation to the control device 110 in response to the response RP. One communication (i.e., a response and confirmation according to one request) is completed by communication packets transmitted and received in steps S11 to S13. As an example, the request RQ in step S11, the response RP in step S12, and the optional confirmation in step S13 may have the same sequence bit SEQ_A or a sequence bit of a continuous value.

Next, in step S14, the server 110 may transmit a request with no response RQNR to the control device 120, as shown in a second section of FIG. 8. The control device 120 may not transmit a response to the request with no response RQNR. As an example, in the case of the request RQNR in step S14, the CON bit is set to ‘0’ and thus the control device 120 does not need to transmit a communication packet having a function code value of 0x00 to the server 110.

Next, in step S15, the control device 120 may transmit the unsolicited response URP to the server 110 as shown in a third section of FIG. 8. In step S16, the server 110 transmits the confirmation CF to the control device 120 in response to the unsolicited response URP. As an example, in the case of the unsolicited response URP in step S15, the CON bit is set to ‘1’, and in response thereto, the server 110 transmits confirmation CF having a function code value of 0x00 to the control device 120.

Next, referring to FIGS. 2 and 9, the server 110 may transmit a request RQ to the control device 120 in step S21, as shown in a first section of FIG. 9. Then, when a response RP is not received from the control device 120 for a certain time (i.e., after a response timeout elapses), the server 110 may retransmit a retransmitted request (RRQ) to the control device 120 in step S22. As an example, the response RP in step S21 and the retransmitted request RRQ in step S22 may have the same sequence bit SEQ_A. As an example, the certain time (i.e., response timeout) may be a time defined by the DNP 3.0 protocol.

Similarly, in step S23, the control device 120 may transmit the unsolicited response URP to the server 110 as shown in a second section of FIG. 9. Then, confirmation CF may not be received from the server 110 for a certain time. In this case, the control device 120 may retransmit a retransmitted unsolicited response RURP in step S24. As an example, the unsolicited response URP in step S23 and the retransmitted unsolicited response RURP in step S24 have the same sequence bit SEQ_A.

As an example, retransmission may not be performed on some of requests transmitted from the server 110. As an example, the requests that have not been retransmitted may include function codes, such as DIRECT_OPERATE(0x05), DIRECT)OPERATE_NR(0x06), DELAY_MEASURE(0x17), RECORD_CURRENT_TIME(0x18), WRITE(0x02) with an Absolute Time object, g50v1, with a Last Recorded Time object, g50v3.

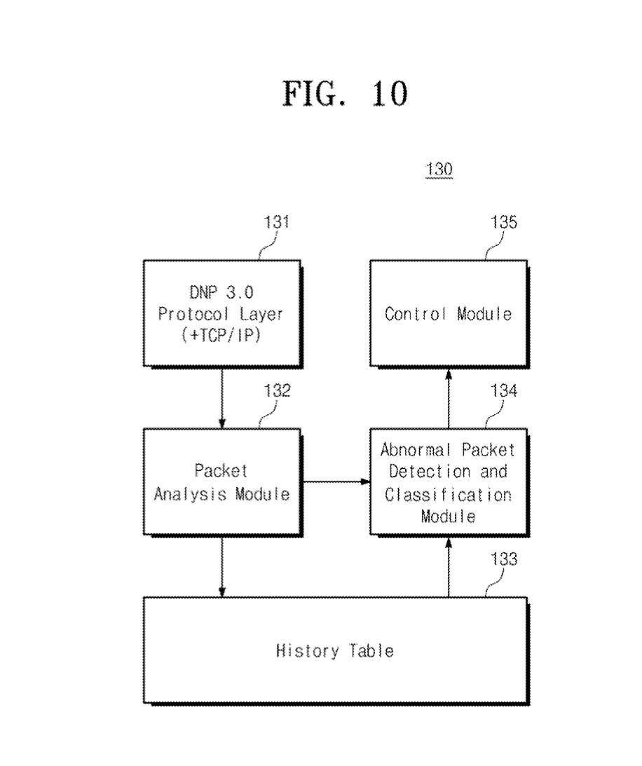

FIG. 10 is a block diagram specifying a packet monitoring device of FIG. 2. Referring to FIGS. 2 and 10, the packet monitoring device 130 includes a DNP 3.0 protocol layer 131, a packet analysis module 132, a history table 133, an abnormal packet detection and classification module 134, and a control module 135. As an example, the modules may be implemented in software or hardware device. For example, a software-type module may be implemented in program commands, program codes, data, tables, etc., and stored in a separate storage medium. A hardware-type module may be implemented in devices, such as a processor, core, MEMS, electric and electronic circuit, passive element, etc. As an example, the modules shown in FIG. 10 may be implemented in software, hardware, or a combination thereof.

The DNP 3.0 protocol layer 131 may be the same as the physical layer described with reference to FIGS. 3 and 4. The DNP 3.0 protocol layer 131 may receive a communication packet transmitted and received between the server 110 and the control device 120 and release the received communication packet. As an example, since the DNP 3.0 protocol layer 131 and its layer structure have been described with reference to FIGS. 3 to 7, their detailed descriptions are omitted.

The packet analysis module 132 may analyze and manage control information from the communication packet released by the DNP 3.0 protocol layer 131. For example, the packet analysis module 132 may manage, in a history table 133, information such as a time when the communication packet is received, the type of the communication packet, the destination field of the communication packet, the finish filed of the communication packet, the start bit of the communication packet, the finish bit of the communication packet, the sequence bit of the communication packet, etc. The history table 133 may manage control information on the communication packet.

The abnormal packet detection and classification module 134 may detect abnormal packets among the received communication packets and classify the type of the detected abnormal packets. For example, the abnormal packet detection and classification module 134 may determine whether the communication packet is an abnormal packet, based on control information on the received communication packet and the history table 133. As an example, the abnormal packet detection and analysis module 134 may classify an abnormal packet detected based on the communication characteristics of the DNP 3.0 protocol as any one of first to fifth abnormal types.

The control module 135 may perform a separate security operation according to the results of the abnormal packet detection and classification of the abnormal packet detection and classification module 134. For example, it is possible to perform security operations, such as the deletion of a received communication packet, the communication release of the server 110 and control device 120, the deletion of the previously received communication packets, etc. according to the results of type classification of the abnormal packet detection and classification module 134.

As described above, the packet monitoring device 130 according to an embodiment of the inventive concept may manage control information on the previously received communication packets in a history table, and compare and analyze control information on the received communication packet and the history table 133 to classify whether the received communication packet is an abnormal packet and an abnormal type. That is, the packet monitoring device 130 may analyze the control information on the received communication packet based on the communication characteristics of the DNP 3.0 protocol and classify the type of an abnormal packet to sense various attack patterns for the control system 100. Thus, a packet monitoring device and a packet monitoring method for a communication packet that have enhanced reliability are provided.

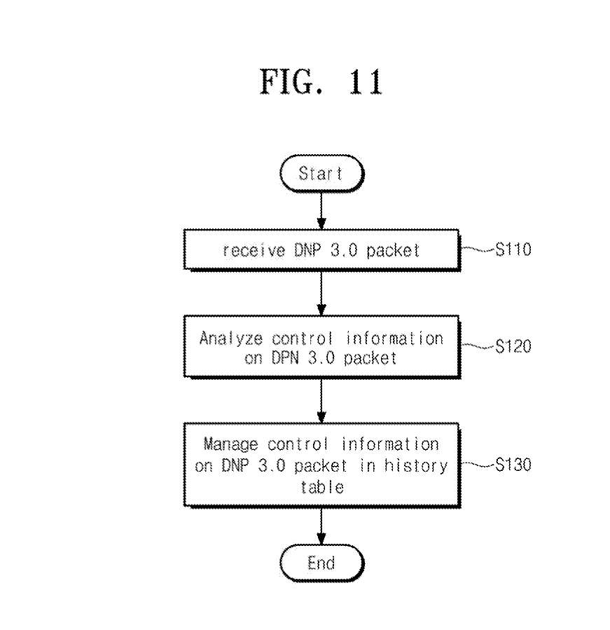

FIG. 11 is a flowchart of an operation of the packet monitoring device of FIG. 10. Referring to FIGS. 10 and 11, a packet monitoring device 110 receives a communication packet (i.e., DNP 3.0 packet) in step S110. As an example, the packet monitoring device 110 may receive communication packets that include a DNP 3.0 packet.

In step S120, the packet monitoring device 110 may analyze control information on the received communication packet (i.e., DNP 3.0 packet). For example, the communication packet includes application protocol control information APCI, a transport header TH, and a link header LH. A DNP 3.0 protocol physical layer 131 may extract, from the communication packet, the application protocol control information APCI, the transport header TH, and the link header LH. A packet analysis module 132 may analyze the extracted communication packet includes application protocol control information APCI, transport header TH, and link header LH.

In step S130, the packet monitoring device 110 may manage control information on the communication packet in a history table.

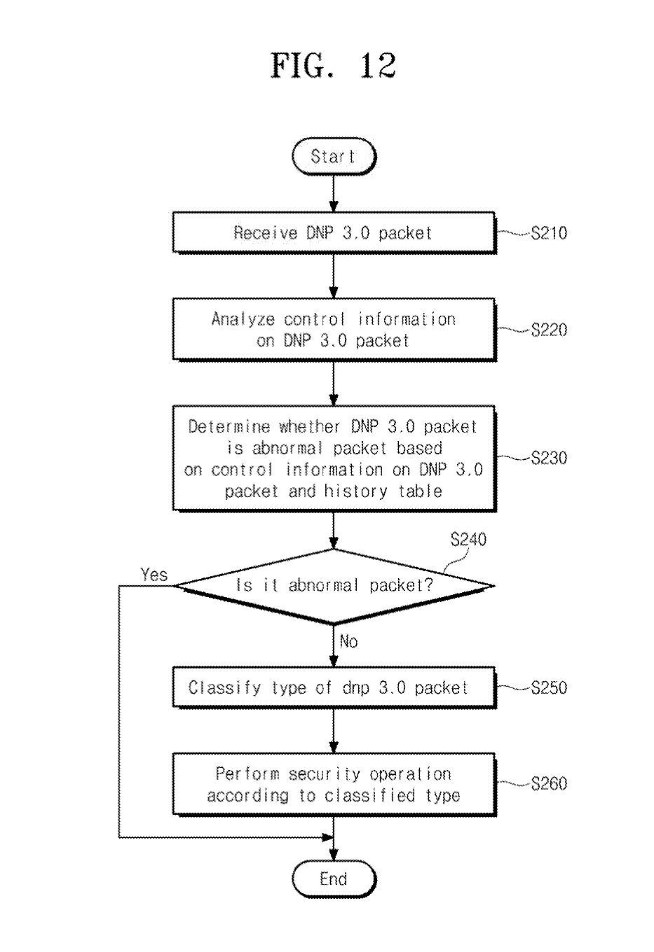

FIG. 12 is a flowchart of another operation of the packet monitoring device of FIG. 10. Referring to FIGS. 10 and 12, a packet monitoring device 120 may receive a communication packet in step S210. As an example, the communication packet may include a DNP 3.0 packet.

In step S220, the packet monitoring device 120 may analyze control information on the received communication packet.

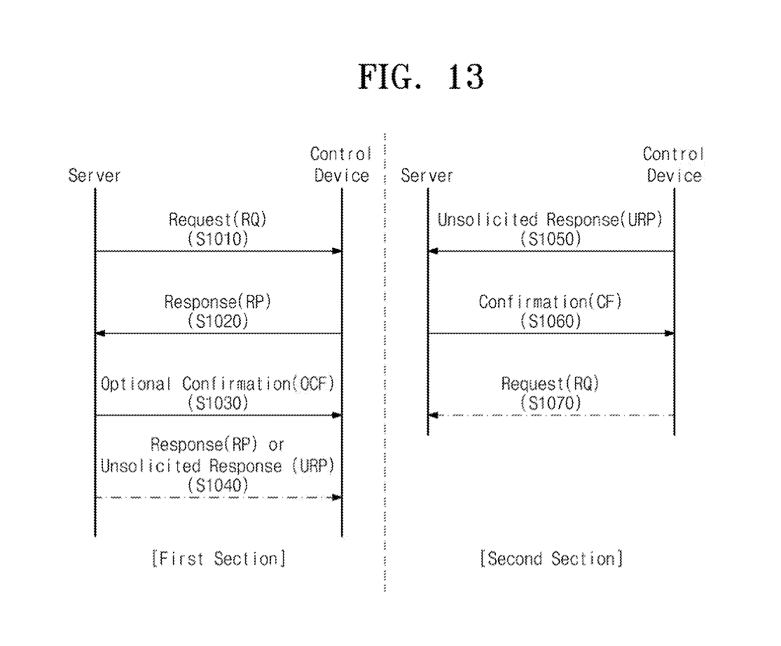

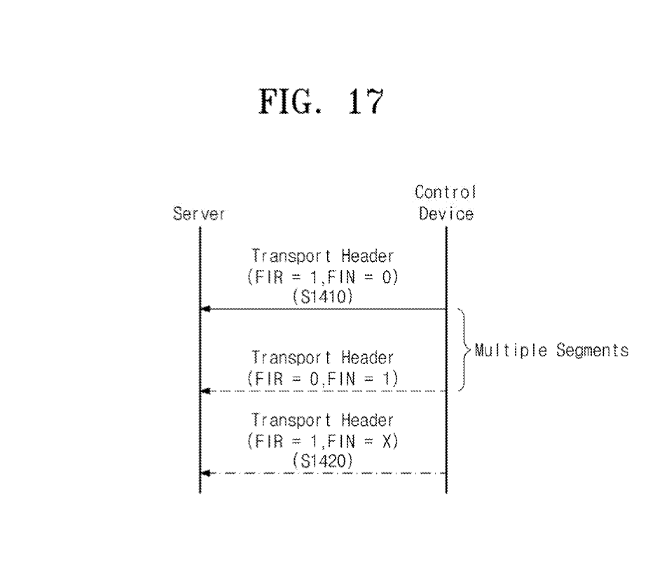

In step S230, the packet monitoring device 120 may determine whether the received communication packet is an abnormal packet, based on the analyzed control information and the history table. For example, the packet monitoring device 120 may compare the destination field, source field, and function code field of the received communication packet to determine whether the received communication packet is an abnormal packet. Alternatively, the packet monitoring device 120 may compare the sequence bit of the received communication packet and the sequence bit included in the history table to determine whether the received communication packet is an abnormal packet. In addition, the packet monitoring device 120 may determine whether the received communication packet is an abnormal packet, based on the control information on the received communication packet and the history table. As an example, the characteristics of an abnormal packet and a method of sensing an abnormal packet are described in more detail with reference to FIGS. 13 to 17.

In step S240, the packet monitoring device 120 may determine whether the communication packet is an abnormal packet.

When as the result of the determination, the received communication packet is an abnormal packet, the packet monitoring device 120 may classify the type of the received communication packet in step S250.

In step S260, the packet monitoring device 120 may perform a security operation according to the classified abnormal type.

According to an embodiment of the inventive concept as described above, the packet monitoring device 120 may manage, in a history table, control information on communication packets transmitted and received between the server 110 and the control device 120, detect an abnormal communication packet based on the history table, and classify an abnormal type. Thus, since it is possible to sense abnormal traffic for various attack patterns, a packet monitoring device and a packet monitoring method for a communication packet that have enhanced reliability are provided.

FIGS. 13 to 17 are diagrams for explaining first to fifth types of an abnormal packet, respectively. In the following, the types of abnormal communication packets according to an embodiment of the inventive concept are described with reference to FIGS. 13 to 17. Also, a method of sensing abnormal types is described with reference to FIGS. 13 to 17. As an example, it is assumed that communication packets in steps by broken lines in FIGS. 13 to 17 are abnormal communication packets and communication packets in steps by solid lines are communication packets that have not been transmitted and received. Also, the packet monitoring device 130 receives communication packets transmitted and received in steps in FIGS. 13 to 17 and analyze control information on the received communication packets to manage the analyzed information in a history table 133. The packet monitoring device 130 analyzes the history table 133 and control information on the communication packet to sense an abnormal communication packet and classifies an abnormal type. However, the scope of the inventive concept is not limited thereto.

Firstly, referring to FIGS. 2, 10, and 13, a server 110 transmits a request RQ to a control device 120 in step S1010, as shown in a first section of FIG. 13. In step S1020, the control device 120 transmits a response RP to the server 110. In step S1030, the server 110 transmits optional confirmation OCF to the control device 120.

Then, the server 110 may transmit the response RP or an unsolicited response URP to the control device 120 in step S1040. The packet monitoring device 130 may sense that the response RP or unsolicited response URP in step S1040 is a first type of abnormal communication packet, based on control information on the response RP or unsolicited response URP in step S1040. As an example, the first type of abnormal communication packet indicates an abnormal communication packet that may not be present between the server 110 and the control device 120.

For example, the server 110, a master device may not transmit the response RP or the unsolicited response URP to the control device 120 in DNP 3.0 protocol communication. The source field of application protocol control information ACPI on the response RP or unsolicited response URP in step S1040 includes information on the server 110, the destination filed includes information on the control device 120, and the function code field includes a value (i.e., a value between 0x33 and 0xFF) corresponding to the response. That is, by analyzing the above-described application protocol control information ACPI, the packet monitoring device 130 may sense that the received communication packet (i.e., communication packet in step S1040) is the first type of abnormal communication packet.

Next, in step S1050, the control device 120 transmits the unsolicited response URP to the server 110 as shown in a second section of FIG. 13. In step S1060, the server 110 transmits confirmation CF to the control device 120.

Then, in step S1070, the control device 120 may transmit a request RQ to the server 110. The packet monitoring device 130 may sense that the request RQ in step S1070 is the first type of abnormal communication packet, based on the control information on the request RQ in step S1070. As an example, the first type of abnormal communication packet indicates an abnormal communication packet that may not be present between the server 110 and the control device 120.

For example, the control device 120, a slave device may not transmit the request RQ to the server 110 in DNP 3.0 protocol communication. The source field of a link header LH of the request in step S1070 includes information on the control device 120, the destination filed of the link header LH includes information on the server 110, and the function code field of the application protocol control information ACPI includes a value (i.e., a value between 0x01 and 0x32) corresponding to the request. That is, by analyzing the above-described application protocol control information ACPI, the packet monitoring device 130 may sense that the received communication packet (i.e., communication packet in step S1070) is the first type of abnormal communication packet.

As an example, the packet monitoring device 130 may manage control information on the transmitted and received communication packet in a history table 133, and thus sense the first type of abnormal communication packet as described above. As an example, the packet monitoring device 130 may sense the first type of abnormal packet as described above, based on the IP or address of the server 110 or the IP or address of the control device 120 included in the TCP/IP layer of the communication packet instead of the source field and destination field of the link header LH.

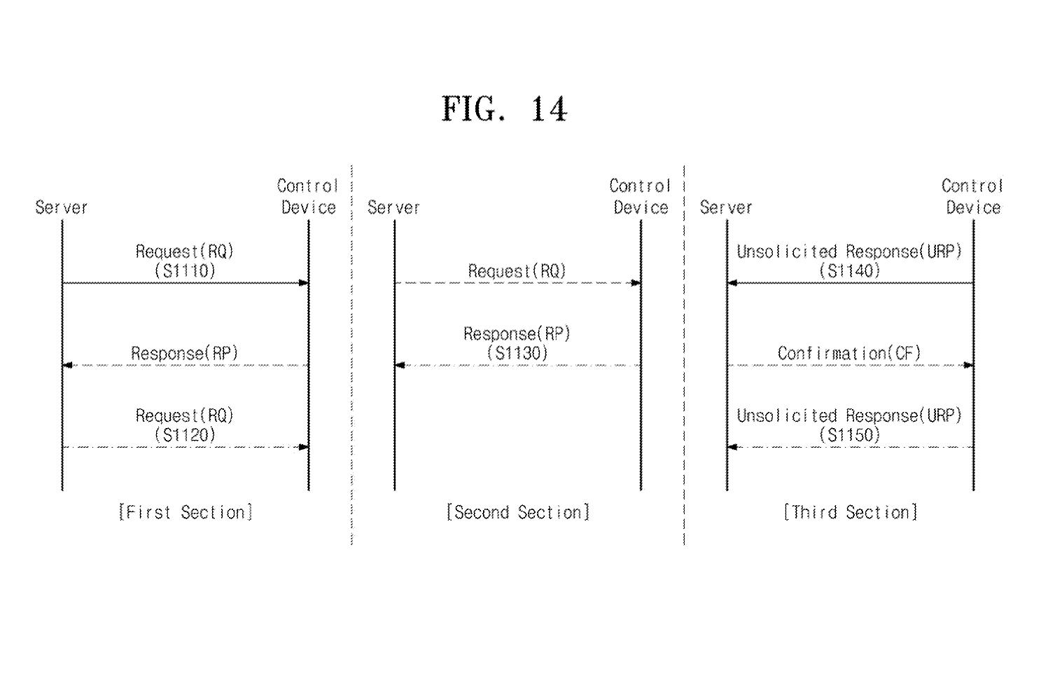

Next, referring to FIGS. 2, 10, and 14, the server 110 may transmit a request RQ to the control device 120 in step S1110, as shown in a first section of FIG. 14. Then, in step S1120, the server 110 may transmit the request RQ. As an example, it is assumed that no communication packet is transmitted between the server 110 and the control device 120 between steps S1110 and S1120. That is, in step S1120, the server 110 transmits the request RQ to the control device 120 without receiving, from the control device 120, a response RP having the same sequence bit SEQ_A as the request RQ in step S1110.

The packet monitoring device 130 may sense that the retransmitted request RQ in step S1120 is a second type of abnormal communication packet. As an example, the second type of abnormal communication packet indicates a communication packet that is against the completion of the transmission and reception of a normal communication packet in DNP 3.0 protocol communication.

For example, the packet monitoring device 130 may manage the source filed and destination field of the link header LH of requests RQ in steps S1110 and S1120 and the sequence bit SEQ_A of the application protocol control information ACPI. The packet monitoring device 130 may sense that a response RP having the same sequence bit as the sequence bit SEQ_A of the request RQ in step S1110 has not been transmitted from the control device 120 to the server 110. This may be sensed based on the sequence bit SEQ_A of the communication packet. That is, the packet monitoring device 130 may sense that the request RQ in step S1120 is the second type of abnormal communication packet.

Next, in step S1130, the control device 120 may transmit a response RP to the server 110 even through the request RQ is not received from the server 110, as shown in a second section of FIG. 14. The packet monitoring device 130 may sense that the response RP in step S1130 is the second type of abnormal communication packet. This may be sensed by searching for the request corresponding to the response RP in step S1130 among the previously received communication packets in the history table. That is, in the case that the response RP in step S1130 is a normal packet, a request having the same sequence bit SEQ_A as the response RP in step S1130 and having corresponding destination field and source field would be in the history table. In the case that there is no corresponding request RQ, the packet monitoring device 130 may sense that the response RP in step S1130 is the second type of abnormal communication packet.

In step S1140, the control device 120 may transmit an unsolicited response URP to the server 110 as shown in a third section of FIG. 14. In step S1150, the control device 120 may transmit an unsolicited response URP to the server 110. As an example, it is assumed that no communication packet is transmitted between the server 110 and the control device 120 between steps S1140 and S1150, like the first section of FIG. 14. That is, in step S1140, the control device 120 transmits the unsolicited response URP to the server 110 without receiving, from the server 110, confirmation CF having the same sequence bit SEQ_A as the unsolicited response URP in step S1140

The packet monitoring device 130 may sense that the retransmitted request RQ in step S1150 is the second type of abnormal communication packet. As an example, the second type of abnormal communication packet indicates a communication packet that is against the completion of the transmission and reception of a normal communication packet in DNP 3.0 protocol communication.

For example, the packet monitoring device 130 may manage the source filed and destination field of the link header LH of the unsolicited responses URP in steps S1140 and S1150 and the sequence bit SEQ_A and unsolicited response bit UNS of the application protocol control information ACPI. The packet monitoring device 130 may sense that confirmation CF having the same sequence bit as the sequence bit SEQ_A of the unsolicited response URP in step S1140 has not been transmitted from the server 110 to the control device 120. As an example, since in the case of the confirmation CF for the unsolicited response URP, an unsolicited response bit UNS is set to ‘1’, it may be sensed that the confirmation has not been transmitted from the server 110 to the control device 120. That is, the packet monitoring device 130 may sense that the unsolicited response URP in step S1150 is the second type of abnormal communication packet.

As an example, the packet monitoring device 130 may further analyze the function code field of application protocol control information APCI on the communication packets transmitted and received in steps in FIG. 4 to enhance accuracy in identification and classification.

As an example, the request RQ in step S1120 and the unsolicited response URP in step S1150 may not be communication packets retransmitted after a critical time. That is, after the request RQ or the unsolicited response URP is transmitted, the response RP or the confirmation CR may not be received for a certain time (that is, a timeout time), as described with reference to FIG. 9. In this case, the request RQ or the unsolicited response URP is retransmitted in DNP 3.0 protocol communication. However, the request RQ in step S1120 or the unsolicited response URP in step S1150 in FIG. 14 is communication packets transmitted before a certain time from when the request RQ in step S1110 or the unsolicited response URP in step S1150 is transmitted elapses. That is, the request RQ in step S1120 or the unsolicited response URP in step S1150 in FIG. 14 would be a communication packet that is against the completion of the transmission and reception of a normal communication packet in normal DNP 3.0 protocol communication. The packet monitoring device 130 may manage the transmission and reception times of transmitted and received communication packets, determine whether the request RQ in step S1120 or the unsolicited response URP in step S1150 is a communication packet transmitted before a certain time from when the previous communication packet is transmitted, and sense that the request RQ in step S1120 or the unsolicited response URP in step S1150 is the second type of abnormal communication packet.

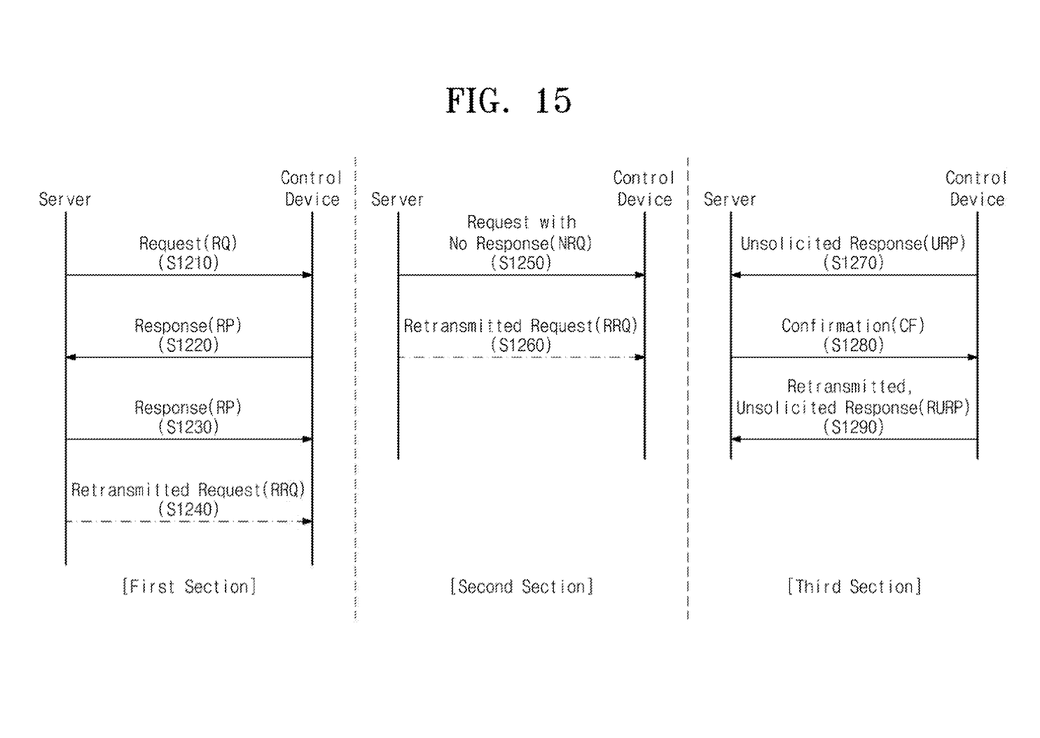

Next, referring to FIGS. 2, 10, and 15, the server 110 may transmit a request RQ to the control device 120 in step S1210, as shown in a first section of FIG. 15. In step S1220, the control device 120 transmits a response RP to the server 110. In step S1230, the server 110 transmits optional confirmation OCF to the control device 120.

Then, in step S1240, the server 110 may retransmit a request RRQ to the control device 120. The packet monitoring device 130 may sense that the request RRQ in step S1240 is a third type of abnormal communication packet. As an example, the third type of abnormal communication packet indicates a retransmission communication packet for a communication packet, the transmission and reception of which have been completed.

For example, the packet monitoring device 130 may analyze control information on the request RQ in step S1210, the response RP in step S1220, and the optional confirmation OCF in step S1230 based on a history table 133 to determine that the transmission and reception of communication packets transmitted and received in steps S1210 to S1230 have been completed (i.e., the transmission and reception of a communication packet for one request have been completed), and based on this, the packet monitoring device 130 may sense that the retransmitted request RRQ in step S1240 is the third type of abnormal packet. That is, since the retransmitted request RRQ in step S1230 is a retransmitted request RRQ having the same sequence bit SEQ_A as a communication packet, the transmission and reception of which have been completed, the packet monitoring device 130 may sense it as the third type of abnormal packet.

Next, in step S1250, the server 110 may transmit a request RQ to the control device 120 as shown in a second section of FIG. 15. As an example, the request RQ in step S1250 may be a request that does not require retransmission and a response. The packet monitoring device 130 may analyze the function code filed of application protocol control information ACPI on the request RQ in step S1250 to check that the request RQ in step S1250 is a request not requiring retransmission and a response. As an example, the request not requiring the retransmission and response may be requests that have the function code filed described with reference to FIG. 8.

Then, in step S1260, the server 110 may retransmit a request RRQ to the control device 120. The retransmitted request RRQ in step S1260 may be a retransmitted request for the request RQ in step S1250. However, in the case that the request RQ in step S1250 is a request not requiring retransmission and a response, the retransmitted request RRQ in step S1260 would be the third type of abnormal packet. The packet monitoring device 130 may sense that the retransmitted request RRQ in step S1260 is the third type of abnormal packet, based on a history table and control information on the retransmitted request RRQ in step S1260.

Next, in step S1270, the control device 120 may transmit an unsolicited response URP to the server 110 as shown in a third section of FIG. 15. In step S1280, the server 110 may transmit confirmation CF to the control device 120. Then, in step S1290, the control device 120 may retransmit the unsolicited response RURP to the server 110. The packet monitoring device 130 may sense that the retransmitted unsolicited response RURP in step S1280 is the third type of abnormal packet.

For example, the packet monitoring device 130 may analyze control information on the response URP in step S1270, and confirmation CF in step S1280 based on a history table 133 to determine that the transmission and reception of communication packets transmitted and received in steps S1270 and S1280 have been completed (i.e., the transmission and reception of a communication packet for one request have been completed), and based on this, the packet monitoring device 130 may sense that the retransmitted unsolicited response RURP in step S1290 is the third type of abnormal packet. That is, since the retransmitted unsolicited response RURP in step S1290 is a retransmitted unsolicited response having the same sequence bit SEQ_A as a communication packet, the transmission and reception of which have been completed, the packet monitoring device 130 may sense it as the third type of abnormal packet.

As an example, the packet monitoring device 130 may further analyze additional information (e.g., a function code field or separate identification data, etc.) to sense the third type of abnormal packet.

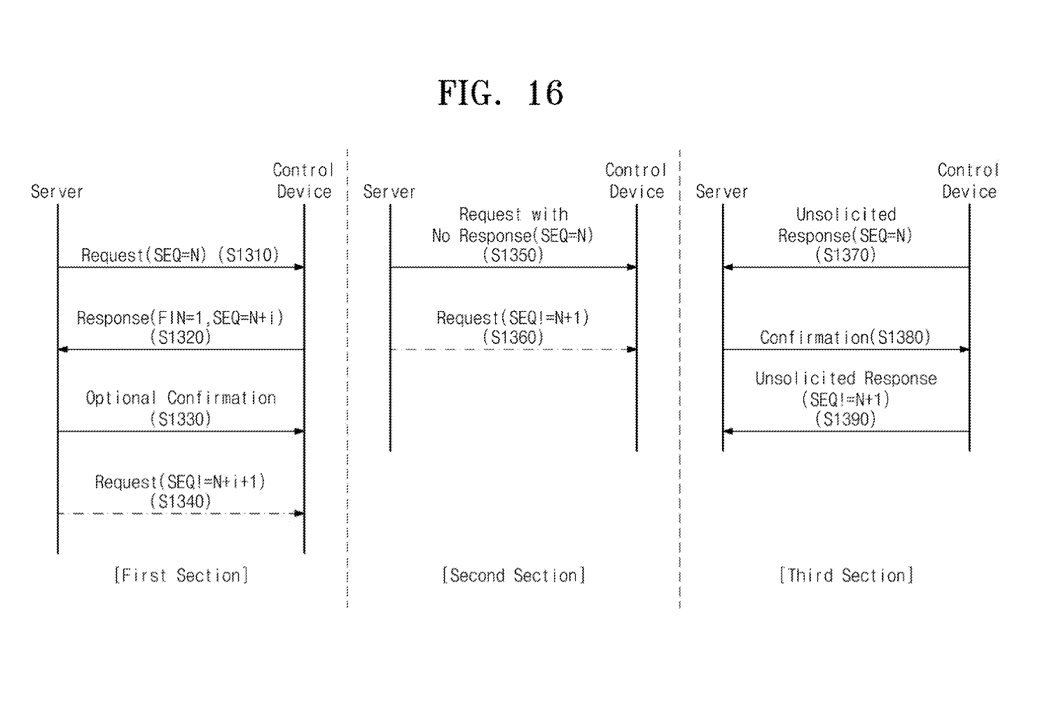

Next, referring to FIGS. 2, 10, and 16, the server 110 may transmit a request RQ to the control device 120 in step S1310, as shown in a first section of FIG. 16. In this example, the sequence bit SEQ_A of the request RQ may have a value of ‘N’. Then, in step S1320, the control device 120 may transmit a response to the control device 120. In this case, the sequence bit SEQ_A of the last response RP (i.e., the finish bit FIN is set to ‘1’) may have a value of ‘N+i’. As an example, ‘i’ indicates a value that is greater by one than the number of data fragments FRAG of the response RP. In step S1330, the server 110 may transmit optional confirmation OCF to the control device 120.

Then, in step S1340, the server 110 may transmit a request RQ to the control device 120. As an example, the sequence bit of a normal request in DNP 3.0 protocol communication would have a value greater by one than the sequence bit of the last response. That is, in the case that the request RQ in step S1340 is the normal request RQ, the request would have the sequence bit of ‘N+i+1’. However, in the case that the request RQ in step S1340 does not have the sequence bit of ‘N+i+1’, the request RQ in step S1340 is a fourth type of abnormal communication packet. The packet monitoring device 130 may analyze information on the history table 133 and control information on the request RQ in step S1340 to sense that the request RQ in step S1340 is the fourth type of abnormal packet. As an example, the fourth type of abnormal communication packet indicates a communication packet that is against the normal sequence bit in DNP 3.0 protocol communication.

Next, in step S1350, the server 110 may transmit a request RQ to the control device 120 as shown in a second section of FIG. 16. In this case, the request RQ is a request not requiring a response and may have the sequence bit SEQ_A of ‘N’. In step S1360, the server 110 may transmit a request RQ to the control device 120. In the case that the sequence bit SEQ_A of the request in step S1260 is not ‘N+1’, the request RQ in step S1260 is the fourth type of abnormal communication packet, as described above. The packet monitoring device 130 may analyze information on the history table 133 and control information on the request RQ in step S1360 (e.g., sequence bit SEQ_A) to sense that the request RQ in step S1360 is the fourth type of abnormal packet.

Next, in step S1370, the control device 120 may transmit an unsolicited response URP to the server 110 as shown in a third section of FIG. 16. In this example, the sequence bit SEQ_A of the unsolicited response URP may have a value of ‘N’. In step S1380, the server 110 may transmit confirmation CF to the control device 120. In step S1390, the control device 120 may transmit the unsolicited response URP to the server 110. In this case, in the case that the unsolicited response URP in step S1390 is a normal communication packet in DNP 3.0 protocol communication, it would have a sequence bit value greater by one than the sequence bit value of the last unsolicited response (i.e., the unsolicited response URP in step S1270). However, in the case that the unsolicited response URP in step S1390 does not have the above-described sequence bit value, the unsolicited response URP in step S1390 would be the fourth type of abnormal communication packet. The packet monitoring device 130 may analyze information on the history table 133 and control information on the unsolicited response in step S1390 to sense that the unsolicited response URP in step S1390 is the fourth type of abnormal packet.

Lastly, referring to FIGS. 2, 10, and 17, the control device 120 may transmit a response RP to the server 110 in step S1410. As an example, the response RP may include multiple data segments. That is, the response RP may include a plurality of data segments and the control device 120 may sequentially transmit the plurality of data segments to the server. In this case, the start bit FIR of a transport header TH of the firstly transmitted data segment is set to ‘1’, and the finish bit FIN of the transport header TH of the last data segment is set to ‘1’.

In step S1420, the control device 120 transmits a response RP to the server 110. In this case, not all responses RP (i.e., multiple data segments) in step S1410 are received and the start bit FIR of the transport header TH of the response RP in step S1420 may be ‘1’. In this case, the response RP in step S1420 may be a fifth type of abnormal communication packet. As an example, the fifth type of abnormal communication packet indicates a communication packet causing abnormal message insertion in DNP 3.0 protocol communication.

The packet monitoring device 130 may analyze the history table 133 and the transport header TH of the response RP in step S1420 to sense whether the response RP in step S1420 is the fifth type of abnormal communication packet. For example, in the case of a normal communication packet in multiple data segment transmission, a communication packet having a start bit FIR of ‘1’ is transmitted from the control device 120 to the server 110 and then a communication packet having a finish bit FIN of ‘1’ is transmitted from the control device 120 to the server 110. However, if a communication packet having a start bit FIR of ‘1’ is transmitted from the control device 120 to the server 110 before a communication packet having a finish bit FIN of ‘1’ is transmitted from the control device 120 to the server 110, the previously received data segments are removed from the server 110 and thus there may be a damage to data reliability.

The packet monitoring device 130 may analyze the history table 133 and the transport header TH of the response RP in step S1420 to sense whether the response RP in step S1420 is the fifth type of abnormal communication packet. The packet monitoring device 130 may remove an abnormal communication packet according to the results of the sensing to prevent the previously transmitted and received data packet from becoming removed.

As an example, although a method of sensing a type of an abnormal communication packet transmitted and received between the server 110 and the control device 120 has been described with reference to FIGS. 13 to 17, the scope of the inventive concept is not limited thereto. For example, the abnormal communication packet may be transmitted and received by a separate hacking device except for the server 110 and the control device 120. The packet monitoring device 130 is disposed on the communication line CL to be capable of receiving a communication packet transmitted and received by the above-described hacking device, and may sense and classify an abnormal communication packet.

According to the above-described embodiments, the packet monitoring device 130 may analyze control information on a communication packet transmitted and received between the server 110 and the control device 120 and manage the information in the history table 133. The packet monitoring device 130 may analyze the history table 133 and control information on the received communication packet to sense an abnormal communication packet and classify an abnormal type. That is, the packet monitoring device 130 according to an embodiment of the inventive concept provides a more efficient and rapid abnormal traffic detection method than a general count-type method. Thus, a stable and reliable communication service between control systems is provided. Also, the abnormal traffic detection method of the packet monitoring device 130 according to an embodiment of the inventive concept efficiently detects many types of abnormal traffic that may be under DNP 3.0 control protocol through minimum packet analysis.

According to the inventive concept, the packet monitoring device may analyze control information on a communication packet based on distributed network protocol 3.0 to effectively sense an abnormal communication packet and classify a corresponding type. Also, the packet monitoring device quickly discovers and handles security threat in a control system based on the classified type to secure service reliability and availability.

Thus, the packet monitoring device and a packet monitoring method for a communication packet that have enhanced reliability are provided.

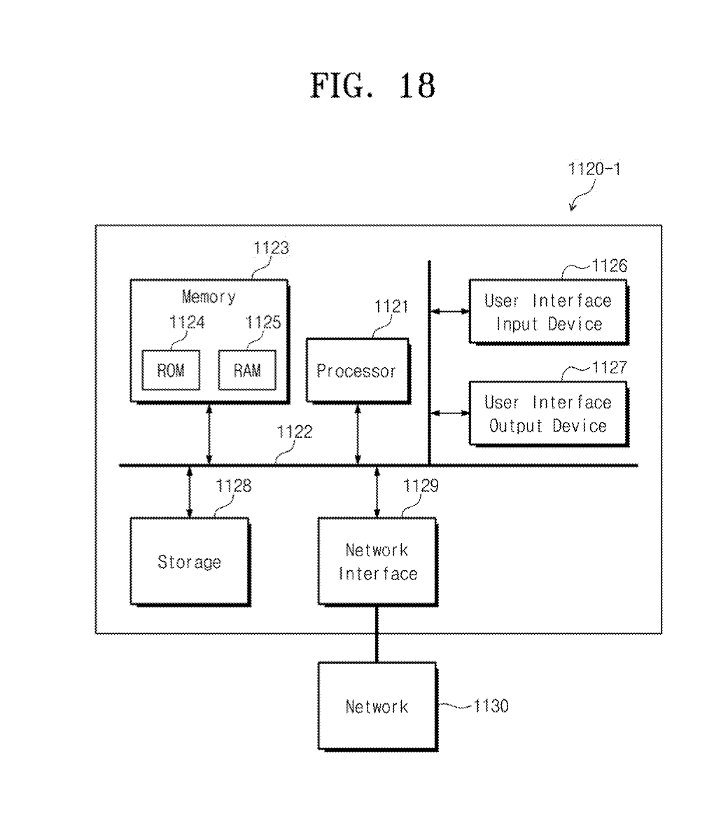

An embodiment of the present invention may be implemented in a computer system, e.g., as a computer readable medium. As shown in in FIG. 18, a computer system 1120-1 may include one or more of a processor 1121, a memory 1123, a user input device 1126, a user output device 1127, and a storage 1128, each of which communicates through a bus 1122. The computer system 1120-1 may also include a network interface 1129 that is coupled to a network 1130. The processor 1121 may be a central processing unit (CPU) or a semiconductor device that executes processing instructions stored in the memory 1123 and/or the storage 1128. The memory 1123 and the storage 1128 may include various forms of volatile or non-volatile storage media. For example, the memory may include a read-only memory (ROM) 1124 and a random access memory (RAM) 1125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

Although the detailed description of the inventive concept has provided particular embodiments, there may be many variations without departing from the scope of the inventive concept. Therefore, the scope of the inventive concept should not be limited to the above-described embodiments but should be defined by equivalents of the following claims as well as the following claims.

What is claimed is:

1. A packet monitoring method for a communication packet transmitted and received between a server and a control device, the packet monitoring method comprising:
receiving the communication packet transmitted and received between the server and the control device;
determining whether the received communication packet is abnormal, based on a history table including control information on communication packets received before the received communication packet and control information on the received communication packet; and
performing a security operation according to results of the determination,
wherein the control information comprises a function code filed of application protocol control information on the communication packet, a sequence bit of the application protocol control information, a source field of a link header, a destination filed of the link header, a start bit of a transport header, and a finish bit of the transport header.

2. The packet monitoring method of claim 1, wherein the server and the control device transmit and receive the communication packet based on distributed network protocol (DNP) 3.0.

3. The packet monitoring method of claim 1, wherein the determining of whether the received communication packet is abnormal comprises classifying the received communication packet as any one of first to fifth types of abnormal communication packets.

4. The packet monitoring method of claim 3, wherein the first type of abnormal communication packet indicates an abnormal communication packet that is not present between the server and the control device,
the second type of abnormal communication packet indicates an abnormal communication packet that is against normal communication between the server and the control device,
the third type of abnormal communication packet indicates an abnormal communication packet that is retransmitted with respect to a communication packet that transmission and reception are completed between the server and the control device,
the fourth type of abnormal communication packet indicates an abnormal communication packet that is against a normal sequence bit between the server and the control device, and
the fifth type of abnormal communication packet indicates an abnormal communication packet that causes abnormal message insertion between the server and the control device.

5. The packet monitoring method of claim 4, wherein the classifying of the received communication packet as any one of the first to fifth types of abnormal communication packets comprises:
classifying the received communication packet as the first type of abnormal communication packet based on the source field of the link header of the received communication packet and the function code field of the application protocol control information.

6. The packet monitoring method of claim 5, wherein the classifying of the received communication packet as the first type of abnormal communication packet comprises:
classifying the received communication packet as the first type of abnormal communication packet when the source field of the link header of the received communication packet indicates the server, the function code field has a value corresponding to a response or an unsolicited response or the source field of the link header of the received communication packet indicates the control device and the function code field has a value corresponding to a request.

7. The packet monitoring method of claim 4, wherein the classifying of the received communication packet as any one of the first to fifth types of abnormal communication packets comprises:
classifying the received communication packet as the second type of abnormal communication packet based on sequence bits and received times of the previously received communication packets in the history table.

8. The packet monitoring method of claim 7, wherein the classifying of the received communication packet as the second type of abnormal communication packet comprises:
classifying the received communication packet as the second type of abnormal communication packet when a communication packet having a same sequence bit as the received communication packet among the previously received communication packets in the history table is received before a certain time.

9. The packet monitoring method of claim 4, wherein the classifying of the received communication packet as any one of the first to fifth types of abnormal communication packets comprises:
classifying the received communication packet as the third type of abnormal communication packet according to whether transmission and reception of communication packets corresponding to the received communication packet among the previously received communication packets are completed.

10. The packet monitoring method of claim 9, wherein the classifying of the received communication packet as any one of the first to fifth types of abnormal communication packets comprises:
classifying the received communication packet as the third type of abnormal communication packet when transmission and reception of a communication packet having a same sequence bit as the received communication packet among the previously received communication packets are completed based on the history table.

11. The packet monitoring method of claim 4, wherein the classifying of the received communication packet as any one of the first to fifth types of abnormal communication packets comprises:
classifying the received communication packet as the fourth type of abnormal communication packet based on sequence bits of the previously received communication packets in the history table.

12. The packet monitoring method of claim 11, wherein the classifying of the received communication packet as the fourth type of abnormal communication packet comprises:
classifying the received communication packet as the fourth type of abnormal communication packet when a sequence bit of the received communication packet is different from a sequence bit according to the DNP 3.0 based on sequence bits of the previously received communication packets in the history table.

13. The packet monitoring method of claim 4, wherein the classifying of the received communication packet as any one of the first to fifth types of abnormal communication packets comprises:
classifying the received communication packet as the fifth type of abnormal communication packet based on start bits and finish bits of the link header of the previously received communication packets in the history table.

14. The packet monitoring method of claim 13, wherein the classifying of the received communication packet as the fifth type of abnormal communication packet comprises:
classifying the received communication packet as the fifth type of abnormal communication packet when a communication packet having a start bit of ‘1’ is received before a communication packet transmitted from the control device to the server and having a finish bit of ‘1’ is received.

15. A packet monitoring device comprising:
a DNP physical layer configured to receive a communication packet transmitted and received between a server and a control device, and release the received communication packet to generate control information and a message;
a communication packet analysis module configured to manage the control information on the received communication packet;
a history table configured to store the control information on the received communication packet and control information on a communication packet received before the received communication packet;
an abnormal packet detection and classification module configured to determine whether the received communication packet is an abnormal communication packet, based on the control information on the previously received communication packet stored in the history table and the control information on the received communication packet; and
a control module configured to perform a security operation according to results of the determination of the abnormal packet detection and classification module,
wherein the control information comprises a function code filed of application protocol control information on the communication packet, a sequence bit of the application protocol control information, a source field of a link header, a destination filed of the link header, a start bit of a transport header, and a finish bit of the transport header.

16. The packet monitoring device of claim 15, wherein the server and the control device transmit and receive the communication packet based on DNP 3.0.

17. The packet monitoring method of claim 16, wherein the DNP physical layer comprises:
a DNP 3.0 data link layer configured to extract the link header from the received communication packet;
a DNP 3.0 transport layer configured to extract the transport header from the received communication packet; and
a DNP 3.0 application layer configured to extract the application protocol control information from the received communication packet.

18. The packet monitoring method of claim 17, wherein the server and the control device communicate with each other through a TCP/IP protocol based communication line, and
the DNP physical layer further comprises a communication protocol layer configured to extract an Ethernet header, an IP header, and a TCP header from the received communication packet.

19. The packet monitoring device of claim 16, wherein the abnormal packet detection and classification module is configured to classify the received communication packet as any one of first to fifth types of abnormal communication packets based on control information on the previously received communication stored in the history table and control information on the received communication packet.

20. The packet monitoring device of claim 19, wherein the first type of abnormal communication packet indicates an abnormal communication packet that is not present between the server and the control device, the second type of abnormal communication packet indicates an abnormal communication packet that is against normal communication between the server and the control device, the third type of abnormal communication packet indicates an abnormal communication packet for a communication packet that transmission and reception are completed between the server and the control device, the fourth type of abnormal communication packet indicates an abnormal communication packet that is against a normal sequence bit between the server and the control device, and the fifth type of abnormal communication packet indicates an abnormal communication packet that causes abnormal message insertion between the server and the control device.
